(19) United States
(12) Patent Application Publication
(10) Pub. No.: US 2015/0316835 A1
(43) Pub. Date: Nov. 5, 2015

(54) CAMERA POSITIONING AND MOUNTING APPARATUS

(71) Applicant: Ryan Douglas Scott, Columbus, OH (US)

(72) Inventor: Ryan Douglas Scott, Columbus, OH (US)

(21) Appl. No.: 14/696,396

(22) Filed: Apr. 25, 2015

Related U.S. Application Data
(60) Provisional application No. 61/987,043, filed on May 1, 2014.

(51) Int. Cl. G03B 17/56; G03B 37/00

(52) U.S. Cl. CPC G03B 17/561; G03B 37/00

(57) ABSTRACT

A camera positioning and mounting apparatus which in some embodiments may comprise four case receiving surfaces with two mounting arms positioned proximate to each case receiving surface. A front camera lens receiving half of a camera case may be hingedly attached to two mounting arms allowing a camera to be temporarily mounted between the front camera lens receiving half of a camera and a case receiving surface. A latching element may be configured to temporarily secure a front camera lens receiving half of a camera case to a case receiving surface. The case receiving surfaces may be joined to a base with each case receiving surface comprising a case locking tab configured to secure a latching element and a case gasket configured to engage and seal the front camera lens receiving half of a camera case to a case receiving surface.

### CROSS REFERENCE TO RELATED APPLICATIONS

This application claims priority to and the benefit of the filing date of U.S. Provisional Application No. 61/987,043, filed on May 1, 2014, entitled “NOVEL PANORAMIC CAMERA POSITIONING AND MOUNTING APPARATUS”, which is hereby incorporated by reference in its entirety.

### FIELD OF THE INVENTION

The present invention relates to novel camera positioning and mounting apparatuses. More particularly, the invention relates to mounting and positioning apparatuses for use with multiple cameras for panoramic recording.

### BACKGROUND

In the world of filmmaking there are hundreds of different types of filming equipment. Unfortunately, this field is divided. Cheap equipment does not provide the quality needed by many filmmakers, and professional equipment is bulky and expensive, often requiring trained personnel to operate. Filming and photographing extreme sports on location with professional equipment and a film crew is prohibitively expensive for most filmmakers, while cheap equipment can break or lead to poor quality results. A new trend in filmmaking is the capture of panoramic and 360 degree field of view recordings. For optimal recordings, between two and six cameras, but optionally between 12 to 14 cameras, may be required to be precisely aligned so that image stitching software may be utilized to merge the separate camera recordings into a single seamless panoramic 360 degree horizontal field of view, or full spherical 360 degree field of view, recording.

An example of a professional image capturing system can be seen in U.S. patent application Ser. No. 11/470,461 filed on Sep. 6, 2006 by Giegerich et al. which describes a structure and method capable of positioning cameras for multiple viewing angles. This structure and method requires a significant investment of time, personnel, and finances in order to use, and is therefore outside the reach of the majority of filmmakers. Also, many on-location environments are unable to support this setup.

Often the filmmaker is the only person on the film crew and is also required to appear in the recording. To mount more than one camera to achieve panoramic and spherical 360 degree field of view recordings, filmmakers have created all sorts of homemade attachments, accessories, and mounts which are frequently made from wood scraps, cardboard, scavenged parts, and even duct tape. These temporary solutions are specific to each filmmaker's needs for a particular situation and must be disassembled once the needs or available equipment changes. A significant amount of time and money can be wasted on trying to fabricate or reconfigure a camera mount for different panoramic and 360 degree field of view recording situations resulting in longer and more expensive film production.

While there are camera mounting and positioning systems in the art, they are limited in many aspects. They are configured for a limited amount of mounting and positioning options and are unable to work with different systems and cameras resulting in the filmmaker needing multiple systems for each video shoot. They are also unable to provide precise alignment of multiple cameras required for achieving panoramic and 360 degree field of view recordings.

Therefore a need exists for novel camera positioning and mounting apparatuses capable of positioning multiple cameras for obtaining panoramic and spherical 360 degree field of view recordings. There is also a need for camera positioning and mounting apparatuses capable of accepting and receiving different cameras and accessories. There is a further need for camera positioning and mounting apparatuses that are able to secure to a variety of structures in order to accommodate small or no film crew situations. A further need exists for novel camera positioning and mounting apparatuses that are rapidly deployable, allow for repeated precise alignment of the cameras in relation to each other, and are designed with numerous attachment points to spread the load across the apparatus in an effort to prevent breakage/detachment from the surface the apparatus is mounted to. Finally, there is a need for camera positioning and mounting apparatuses that are rapidly reconfigurable and interchangeable without tools to adapt to different environments.

### BRIEF SUMMARY OF THE INVENTION

A novel camera positioning and mounting apparatus is provided. In some embodiments, the apparatus may comprise a set of case receiving surfaces each configured to removably couple with a portion of a camera case that may be coupled to the base. The apparatus may also comprise a set of retaining arms, with each retaining arm coupled to and radially protruding outwardly away from the base and also each coupled to a case receiving surface. A mounting arm configured to removably couple with a portion of a camera case may be positioned proximate to, such as below or along the perimeter, the case receiving surfaces.

In further embodiments, the apparatus may comprise a first retaining arm extending outwardly away from the center of the apparatus, with the first retaining arm supporting a first case receiving surface. A second retaining arm may be positioned adjacent to the first retaining arm and may extend outwardly away from the center of the apparatus, with the second retaining arm supporting a second case receiving surface. A third retaining arm may be positioned adjacent to the second retaining arm and may extend outwardly away from the center of the apparatus, with the third retaining arm supporting a third case receiving surface. A fourth retaining arm may be positioned adjacent to the third retaining arm and may extend outwardly away from the center of the apparatus, with the fourth retaining arm supporting a fourth case receiving surface. Each of the case receiving surfaces may be adapted to removably couple with a portion of a camera case.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a camera positioning and mounting apparatus according to various embodiments described herein.

FIG. 2 illustrates a side elevation view of an example of a camera positioning and mounting apparatus according to various embodiments described herein.

FIG. 3 shows a top plan view of an example of a camera positioning and mounting apparatus according to various embodiments described herein.

FIG. 4 depicts a bottom plan view of an example of a camera positioning and mounting apparatus according to various embodiments described herein.

FIG. 5 illustrates a perspective view of an example of a camera positioning and mounting apparatus securing four front camera lens receiving halves of four camera cases according to various embodiments described herein.

FIG. 6 shows a perspective view of an example of a camera positioning and mounting apparatus securing four front camera lens receiving halves of four camera cases with cameras according to various embodiments described herein.

FIG. 7 depicts a perspective view of an example of a camera positioning and mounting apparatus securing four front camera lens receiving halves of four camera cases with attached suction cups according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New camera positioning and mounting apparatuses which may be used for panoramic recording are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

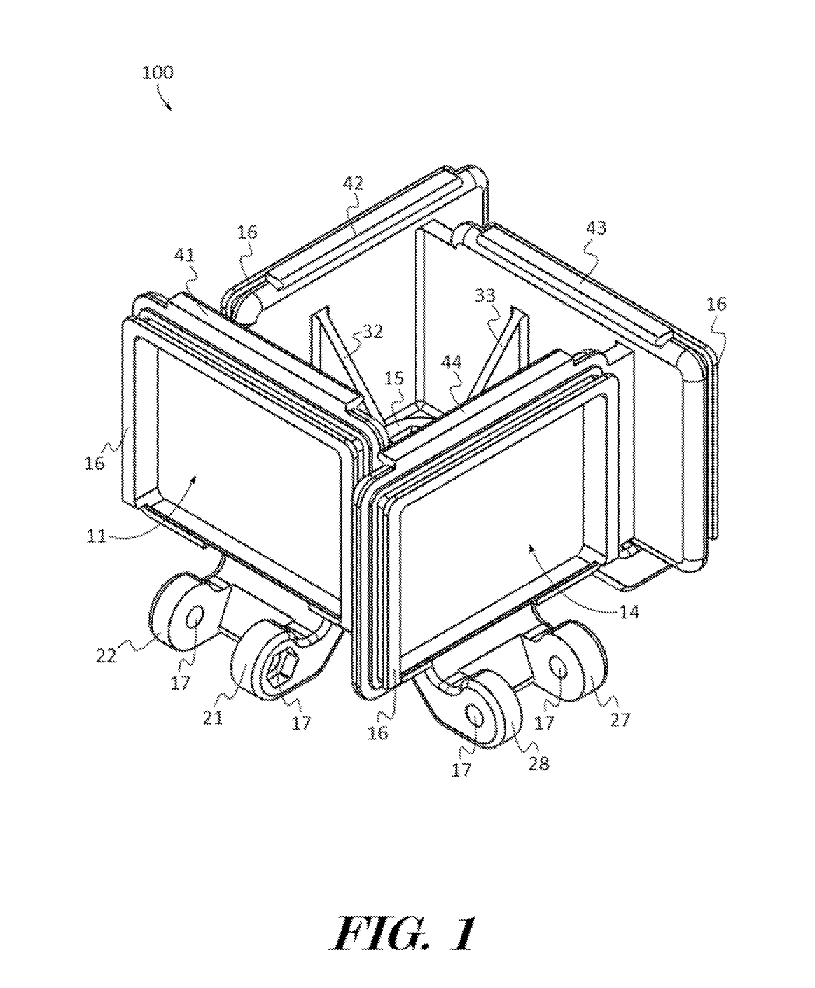

The present invention will now be described by example and through referencing the appended figures representing preferred and alternative embodiments. FIGS. 1-4 illustrate an example of a camera positioning and mounting apparatus (“the apparatus”) 100 according to various embodiments. In this example, the apparatus 100 comprises a set of retaining arms 31, 32, 33, 34, each coupled to and radially protruding outwardly away from a base 15. A set of case receiving surfaces 11, 12, 13, 14, each configured to removably couple with a portion of a camera case, may each be coupled to the base 15 and to a retaining arm 31, 32, 33, 34.

In some embodiments, the apparatus 100 may comprise a first retaining arm 31 extending outwardly away from the center 19 of the apparatus 100, with the first retaining arm 31 supporting a first case receiving surface 11. A second retaining arm 32 may be positioned adjacent to the first retaining arm 31 and may extend outwardly away from the center 19 of the apparatus 100, with the second retaining arm 32 supporting a second case receiving surface 12. A third retaining arm 33 may be positioned adjacent to the second retaining arm 32 and may extend outwardly away from the center 19 of the apparatus 100, with the third retaining arm 33 supporting a third case receiving surface 13. A fourth retaining arm 34 may be positioned adjacent to the third retaining arm 33 and may extend outwardly away from the center 19 of the apparatus 100, with the fourth retaining arm 34 supporting a fourth case receiving surface 14. Each of the case receiving surfaces 11, 12, 13, 14, may be adapted to removably couple with a portion of a camera case.

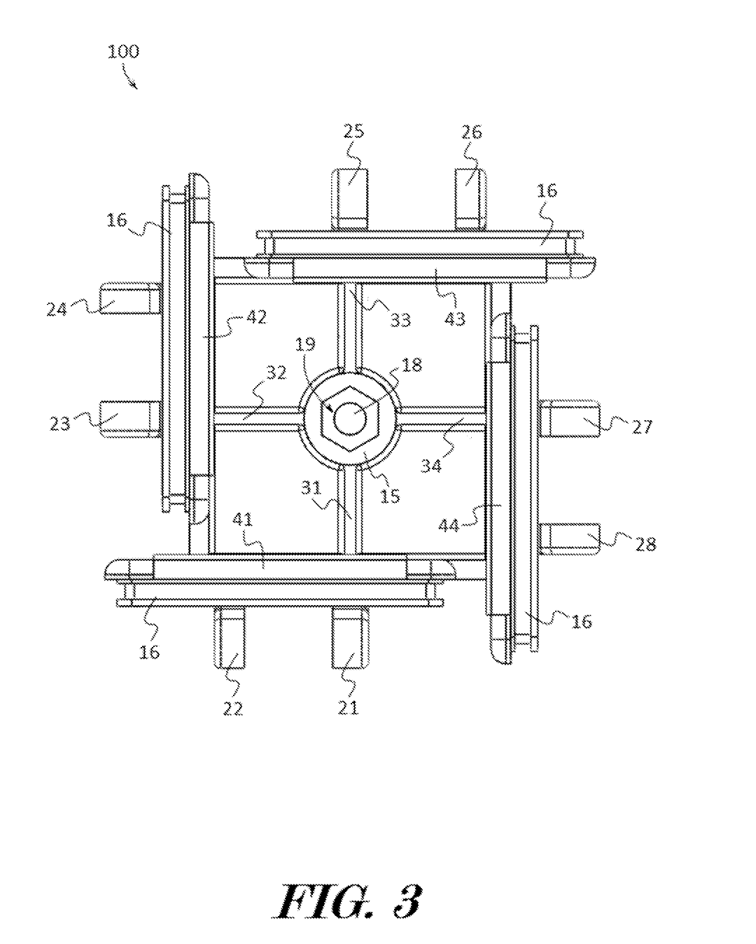

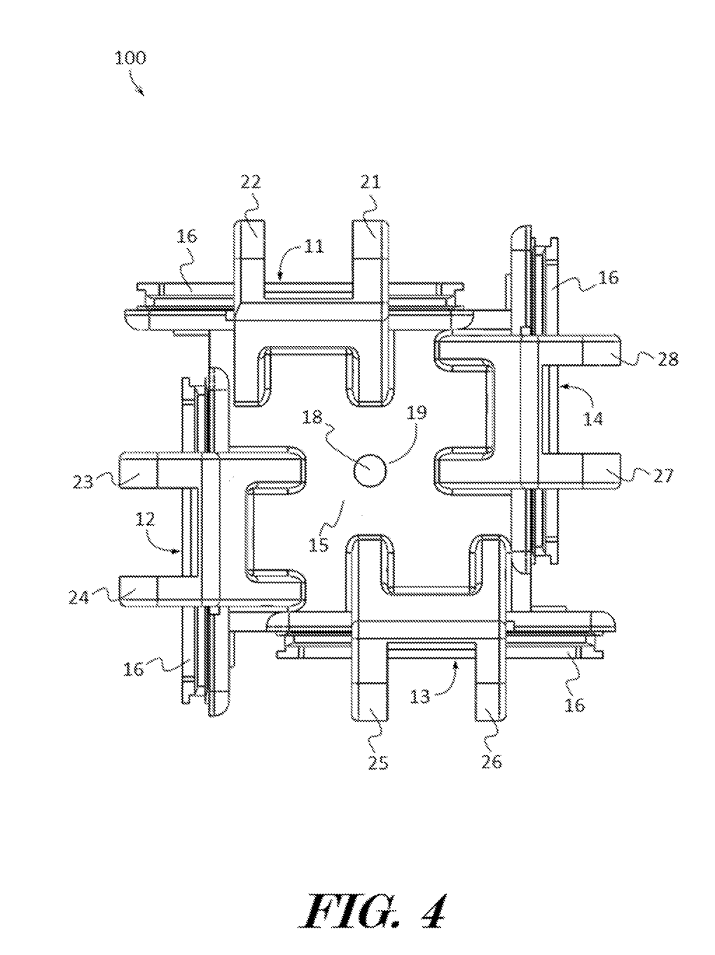

The base 15 may form the center 19 of the apparatus 100 with each case receiving surface 11, 12, 13, 14, of the set of case receiving surfaces coupled to the base 15. The case receiving surfaces 11, 12, 13, 14, may be substantially planar in shape and may be preferably joined to the base 15 in a perpendicular fashion with two case receiving surfaces 11, 13, parallel to each other and perpendicularly joined to the two parallel case receiving surfaces 12, 14. In alternative embodiments, the apparatus 100 may comprise a set of two, three, five, six, seven, eight, nine, ten, eleven, twelve, thirteen, fourteen, or more case receiving surfaces, with each coupled to the base plate 15 (FIGS. 3 and 4) in a perpendicular, parallel, or any other spatial arrangement. For example, in embodiments comprising three case receiving surfaces, the case receiving surfaces may be joined in a substantially triangular spatial arrangement. In embodiments comprising five or six case receiving surfaces 11, the case receiving surfaces may be joined in a substantially cube like, rectangular prism, pentagon, hexagon, or any other spatial arrangement.

In some embodiments, a case receiving surface 11, 12, 13, 14, may be coupled directly to the base 15. In other embodiments, the apparatus 100 may comprise a set of retaining arms 31, 32, 33, 34, with each retaining arm 31, 32, 33, 34, coupled to the base 15 and radially protruding outwardly away from the base 15, such as from the center 19 of the apparatus 100. Each case receiving surface 11, 12, 13, 14, of the set of case receiving surfaces may then be coupled, such as in a substantially perpendicular, parallel, or with any other spatial arrangement or orientation, to a retaining arm 31, 32, 33, 34, of the set of retaining arms, thereby coupling each case receiving surface 11, 12, 13, 14, to the base 15.

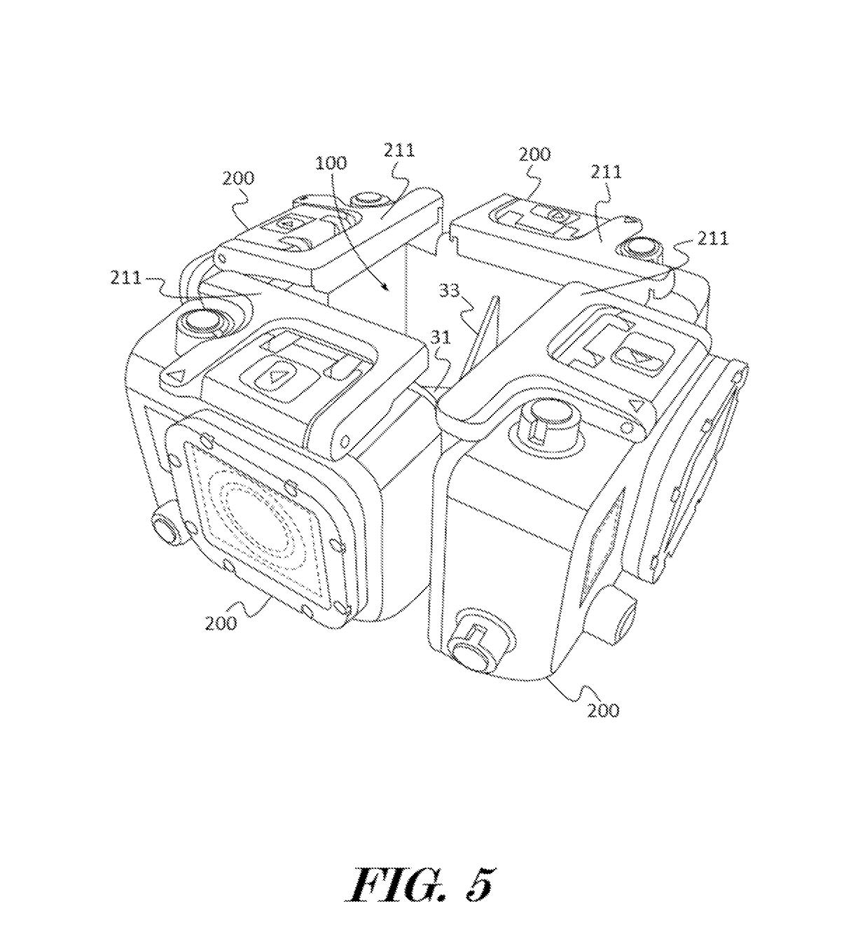

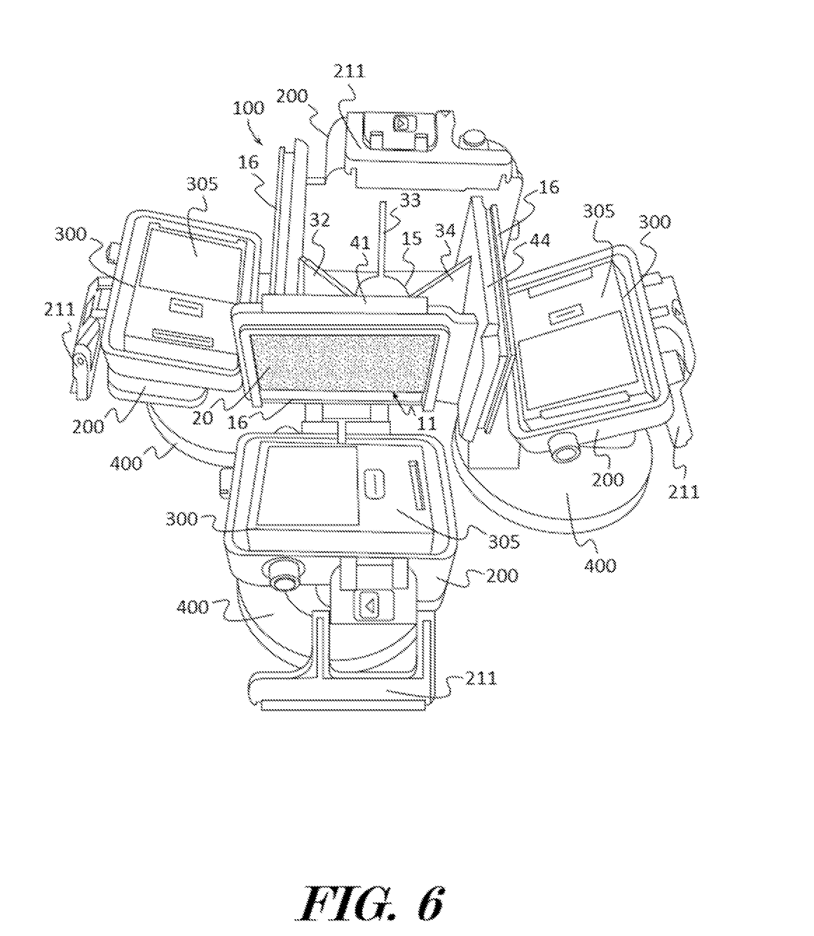

Each case receiving surface 11, 12, 13, 14, may comprise a case locking tab 41, 42, 43, 44, and a gasket 16. In some embodiments, a case receiving surface 11, 12, 13, 14, may be substantially planar in shape and configured to contact the rear surface 305 of a camera 300 (FIG. 6) which may also be substantially planar in shape. The apparatus 100 may be configured to secure or mount a camera 300 by placing the rear surface 305 against a case receiving surface 11, 12, 13, 14, such as within the gasket 16. The gasket 16 and a case locking tab 41, 42, 43, 44, are configured to complementarily mate with portions of a camera case such as a front camera lens receiving half of a camera case 200 (FIGS. 5-7) with the case locking tab 41, 42, 43, 44, configured to accept and secure a camera case latching element 211 (FIGS. 5-7) such as a snap lock latches, catches, latches, clips, clamps, or any other temporary attachment element configured to secure portions of a Clam shell type camera case together. A case locking tab 41, 42, 43, 44, may be coupled, such as by being integrally formed or molded or otherwise coupled with each case receiving surface 11, 12, 13, 14, preferably to the top of a case receiving surface 11, 12, 13, 14, and opposite to the set of mounting arms 21, 22, 23, 24, 25, 26, 27, 28, positioned proximate to, such as below, the case receiving surface 11, 12, 13, 14. A case locking tab 41, 42, 43, 44, may extend up and away from the case receiving surface 11, 12, 13, 14, to provide a point of attachment for a case latching element 211 to removably couple to. In this manner, each case locking tab 41, 42, 43, 44, may be adapted to complementary mate with and be removably coupled to a camera case latching element 211, thereby allowing a portion of the front camera lens receiving half of a camera case 200 to removably couple over or to a gasket 16 and/or also to a case receiving surface 11, 12, 13, 14.

In some embodiments, a gasket 16 may be formed onto a case receiving surface 11, 12, 13, 14, such as along the perimeter of a case receiving surface 11, 12, 13, 14. Generally, a gasket 16 may comprise a rectangular shape which extends away from a case receiving surface 11, 12, 13, 14, and is configured to contact or mate with the front camera lens receiving half 200 (FIGS. 5-7) of clam shell type camera cases. A gasket 16 may comprise a similar rectangular shape and dimensions as a gasket which is commonly found on the back half of Clam shell type camera cases. In this manner, a gasket 16 may be configured to contact and seal the front camera lens receiving half 200 (FIGS. 5-7) to a case receiving surface 11, 12, 13, 14, in a similar manner as the gasket on the back half of a Clam shell type camera case would when a front camera case 200 is closed or removably coupled to a case receiving surface 11, 12, 13, 14, thereby preventing water, dirt, and other substances from entering between the front camera lens receiving half 200 and a case receiving surface 11, 12, 13, 14. In some embodiments, a gasket 16 may be made from or comprise a flexible material such as silicone, rubber, flexible plastics, foam rubber, and the like. In further embodiments, a gasket 16 may be made from or comprise a rigid material such as rigid plastics, metal and metal alloys, fiber glass, carbon fiber, or any other substantially rigid material such as those which may be used to form case receiving surfaces 11, 12, 13, 14, mounting arms 21, 22, 23, 24, 25, 26, 27, 28, retaining arms 31, 32, 33, 34, and/or a base 15. In further embodiments, a gasket 16 may be configured to engage one or more rear surfaces 305 of a camera 300 (FIG. 6) and act as a socket or receptacle for securing the camera to the gasket 16 and therefore to its respective case receiving surface 11, 12, 13, 14.

In some embodiments and as shown in FIG. 6, a case receiving surface 11, 12, 13, 14, may comprise a pad 20 which may be positioned within the gasket 16. A pad 20 may function as a cushion between the rear surface 305 of a camera 300 (FIG. 6) and a case receiving surface 11, 12, 13, 14, and be made of flexible materials such as adhesive backed foam rubber, rubber, silicone, flexible plastic, or any other suitable flexible material that may be coupled to a case receiving surface 11, 12, 13, 14, and act as a cushion. A pad 20 may be any size and substantially planar in shape which may be positioned within a gasket 16. In further embodiments, each of the case receiving surfaces 11, 12, 13, 14, may be coupled to a pad 20 wherein each pad 20 may be configured to be secured, such as with an adhesive or by being pressed between a camera rear surface 305 (FIG. 6) and each of the case receiving surfaces 11, 12, 13, 14.

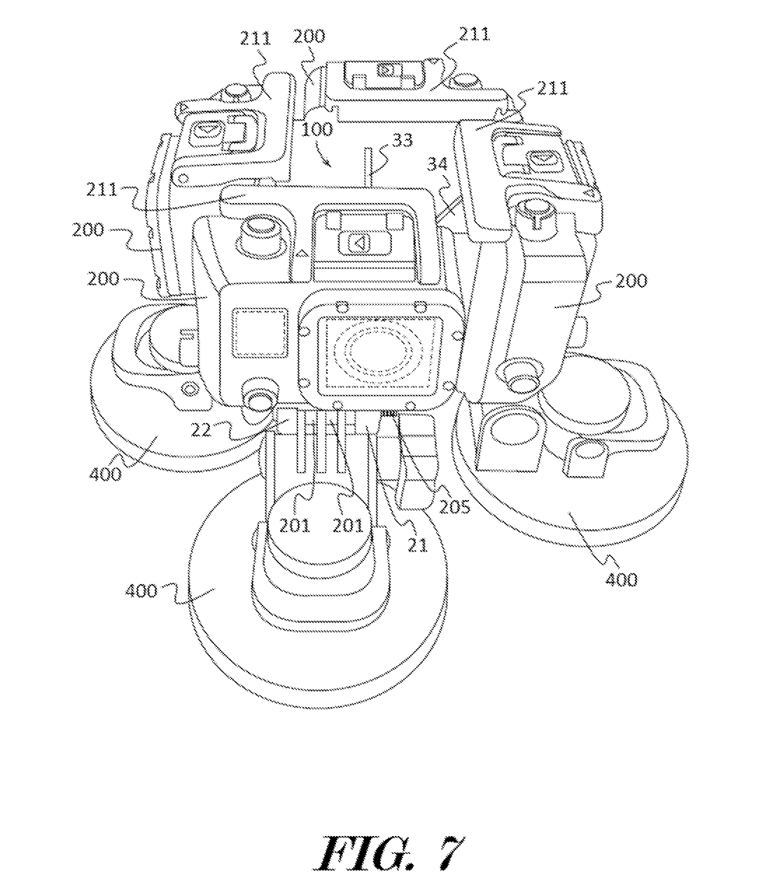

In further embodiments, the apparatus 100 may also comprise a set of two mounting arms 21, 22, 23, 24, 25, 26, 27, 28, positioned proximate to each of the case receiving surfaces 11, 12, 13, 14, such as below or anywhere along the perimeter of a case receiving surface 11, 12, 13, 14. A set of two mounting arms 21, 22, 23, 24, 25, 26, 27, 28, may be coupled to the base 15, a case receiving surface 11, 12, 13, 14, and/or to a retaining arm 31, 32, 33, 34, so that each set of mounting arms 21, 22, 23, 24, 25, 26, 27, 28, may be positioned below each of the case receiving surfaces 11, 12, 13, 14. In other embodiments, one or more mounting arms 21, 22, 23, 24, 25, 26, 27, 28, may be positioned above, below, and/or on one or more sides or on the perimeter of each case receiving surfaces 11, 12, 13, 14. Each mounting arm 21, 22, 23, 24, 25, 26, 27, 28, may comprise a mounting arm aperture 17 configured to receive a fastener 205 (FIG. 7). A fastener 205 may comprise a threaded fastener, captive threaded fasteners, nut, screw, threaded insert, threaded rod, or any other type of threaded or non-threaded fastener. In some embodiments, a mounting arm aperture 17, such as on mounting arm 21 as shown in FIG. 1, may be configured to receive or secure a nut type fastener through which a bolt type fastener 205 may be threaded through.

The mounting arms 21, 22, 23, 24, 25, 26, 27, 28, the base 15, case receiving surfaces 11, 12, 13, 14, and/or retaining arms 31, 32, 33, 34, may be coupled by being connected, removably coupled or connected, or integrally formed or molded with the apparatus 100. In some embodiments, the mounting arms 21, 22, 23, 24, 25, 26, 27, 28, the base 15, case receiving surfaces 11, 12, 13, 14, and/or retaining arms 31, 32, 33, 34, may be made from injected molded nylon, glass filled nylon, other plastics, rigid rubber, metal alloys, carbon fiber, or other similar materials, and they may be coupled or connected together by being integrally formed or molded together as a rigid structure. In other embodiments, the mounting arms 21, 22, 23, 24, 25, 26, 27, 28, the base 15, case receiving surfaces 11, 12, 13, 14, and/or retaining arms 31, 32, 33, 34, may be coupled or connected together to form a rigid structure with heat bonding, chemical bonding, adhesives, clasp type fasteners, clip type fasteners, rivet type fasteners, threaded type fasteners, other types of fasteners, or any other suitable joining method. In other embodiments, the mounting arms 21, 22, 23, 24, 25, 26, 27, 28, the base 15, case receiving surfaces 11, 12, 13, 14, and/or retaining arms 31, 32, 33, 34, may be removably coupled or removably connected to form a rigid structure by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary or removable connection method as one reasonably skilled in the art could envision to serve the same function. In further embodiments, the mounting arms 21, 22, 23, 24, 25, 26, 27, 28, the base 15, case receiving surfaces 11, 12, 13, 14, retaining arms 31, 32, 33, 34, and/or any other element described herein may be coupled to, connected to, or integrally formed with another element of an apparatus 100.

Each of the case receiving surfaces 11, 12, 13, 14, may be adapted to removably couple with a portion, such as the front camera lens receiving half 200 (FIGS. 5-7), of a Clam shell type camera case. Clam shell type camera cases typically comprise two halves, a front camera lens receiving half 200 and a complementary back half which are hingedly joined together along one side and temporarily joined, such as with a latching element, together on another side forming a cavity between the two halves which is configured to accept and secure a camera. The front half 200 and back half of these Clam shell type cases may each comprise one or more vertical prongs and one or more cavities located between two vertical prongs which are configured to interlock together. The vertical prongs of both the front half 200 and back half may also comprise an aperture configured to receive a fastener such as fastener 205 (FIG. 7) which functions as a hinge or pivot point allowing the vertical prongs of the front half 200 to pivot relative to the prongs of the back half, thereby allowing the front half 200 to pivot relative to the back half between an open and closed position. Additionally, vertical prongs also allow for the attachment of mounting apparatuses such as suction cups 400 (FIG. 7), sticky mounts, and the like.

The front camera lens receiving half 200 may typically comprise a latching element 211 (FIGS. 5-7), such as a snap lock latch or any other type of latch, which may temporarily join or engage to a locking tab on the back half. The back half typically may comprise a gasket which extends around the perimeter of the back half and may be configured to contact and seal the front camera lens receiving half 200 to the back half when the camera case is closed, thereby preventing water, dirt, and other substances from entering between the front camera lens receiving half 200 and the back half. These Clam shell type cases may be opened by temporarily unlatching the latching element, allowing the case to pivot open at the hindged joining provided by a fastener 205 (FIG. 7). Often, the hinged joining is formed by a fastener 205 (FIG. 7), such as a threaded fastener, which may extend through a portion of each of the camera case halves. By removing the threaded fastener, the two halves may be separated from each other allowing the front camera lens receiving half 200 to then be removably coupled with a case receiving surface 11, 12, 13, 14.

In some embodiments, a camera 300 (FIG. 6) may be secured within the apparatus 100 by first disassembling a Clam shell type camera case and removing the front camera lens receiving half 200 (FIGS. 5-7) of the case from the complementary back half of the case. The bottom of a front camera lens receiving half of the camera case 200 (FIGS. 5-7) may be hingedly or pivotally secured to one or more mounting arms 21, 22, 23, 24, 25, 26, 27, 28, such as a set of two, below a case receiving surface 11, 12, 13, 14, and therefore to the apparatus 100 by inserting a fastener 205 through the mounting arm aperture 17 of the mounting arms 21, 22, 23, 24, 25, 26, 27, 28, and also through a fastener aperture of the vertical prongs 201 of the front half of the camera case 200. The camera 300 may now be positioned between the camera lens receiving half of a camera case 200 and a case receiving surface 11, 12, 13, 14, with the rear surface 305 of the camera 300 contacting the case receiving surface 11, 12, 13, 14, and/or the pad 20. The top of the front camera lens receiving half of the camera case 200 (FIGS. 5-7) may be pivoted by the pivot point provided by the fastener 205 towards the case receiving surface 11, 12, 13, 14, thereby enclosing the camera 300 within a cavity formed between the two in a similar method as the front camera lens receiving half of the camera case 200 was joined to the complementary back half of the camera case. By pivoting the top of the front camera lens receiving half of the camera case 200 away from a case receiving surface 11, 12, 13, 14, the camera may be accessed without removing the front camera lens receiving half of the camera case 200 (FIGS. 5-7) from the apparatus 100, and without removing the apparatus 100 from its mounted surface. In this manner, the apparatus 100 may remain mounted to a surface or object while still allowing the filmmaker access to remove or replace each individual camera 300 without having to disassemble or otherwise remove the apparatus 100 from its place of mounting, while also providing the ability to swap cameras 300 in/out quickly and efficiently without tools or without disrupting the mounting position.

In other embodiments, the front camera lens receiving half of the camera case 200 (FIGS. 5-7) may be hingedly secured to one or more mounting arms 21, 22, 23, 24, 25, 26, 27, 28, by inserting a bolt-type fastener 205 (FIG. 7) through a securement aperture 17 and through a similarly shaped aperture on a vertical prong 201 (FIG. 7) of a front camera lens receiving half of the camera case 200 and by placing and tightening a nut-type fastener on the bolt-type fastener 205 to prevent their separation. In further embodiments, the front camera lens receiving half of the camera case 200 may be hingedly secured to one or more mounting arms 21, 22, 23, 24, 25, 26, 27, 28, by inserting a first screw-type fastener 205 or any other suitable fastener through a securement aperture 17 of the mounting arms 21, 22, 23, 24, 25, 26, 27, 28, and through a similarly shaped aperture on a front camera lens receiving half of the camera case 200 and by optionally placing and tightening a second fastener on the first fastener to prevent their separation.

Turning now to FIG. 3 and FIG. 4, a top plan view and a bottom plan view respectively, of an example of a camera positioning and mounting apparatus 100 according to various embodiments is shown. In these examples, four case receiving surfaces 11, 12, 13, 14, are each perpendicularly joined to a retaining arm 31, 32, 33, 34. Optionally, to provide further support in maintaining the position of the set of case receiving surfaces 11, 12, 13, 14, a set of four retaining arms 31, 32, 33, 34 may each be attached to the base 15 and to a case receiving surface 11, 12, 13, 14.

In some embodiments, the base 15 may comprise one or more securement apertures 18 which may be configured to receive fastener, such as a threaded fastener, which may be used to secure the apparatus 100 to tripods, vehicles, camera harnesses, camera booms, sporting equipment, or any other mounting device. In other embodiments, a securement aperture 18 may be configured to receive and be secured to a plurality of mounting devices with a threaded screw type connection method, a push-to-lock type connection method, a turn-to-lock type connection method, or any other suitable temporary connection method as one reasonably skilled in the art could envision to serve the same function.

As perhaps best shown by FIG. 5, a perspective view of an example of a camera positioning and mounting apparatus 100 securing four front camera lens receiving halves of four camera cases 200 according to various embodiments described herein is shown. In this example, the latching element 211 of each front camera lens receiving half 200 is temporarily securing and maintain the joining of its respective front camera lens receiving half 200 to a case receiving surface 11, 12, 13, 14, while a fastener 205 (FIG. 7) is also hingedly joining the portion of the front camera case 200 to the case receiving surface 11, 12, 13, 14. A latching element 211 may removably couple to a case locking tab 41, 42, 43, 44, (FIGS. 1-3) and mates the case gasket 16 of a case receiving surface 11, 12, 13, 14, to a front camera lens receiving half of a camera case 200.

FIG. 6 shows a perspective view of an example of a camera positioning and mounting apparatus 100 securing four front camera lens receiving halves of four camera cases 200 with four (three being visible) cameras 300 according to various embodiments of the present invention. In this example, three of the four front camera lens receiving halves of camera cases 200 are shown in the open position allowing access to their respective camera 300. The front camera lens receiving half of a camera case 200 is hingedly joined or attached to one or more mounting arms 21, 22, 23, 24, 25, 26, 27, 28, with a fastener 205 (FIG. 7) allowing the front camera lens receiving half of a camera case 200 to be pivoted away from or towards a case receiving surface 11, 12, 13, 14, when the camera case latching element 211 of the front half of a camera case 200 is uncoupled from a case locking tab 41, 42, 43, 44, of a case receiving surface 11, 12, 13, 14. In the pivoted away or open position, a camera 300 may be placed in, accessed, or removed from between the front camera lens receiving half of a camera case 200 and a case receiving surface 11, 12, 13, 14. When in the closed position by being pivoted towards and contacting a case receiving surface 11, 12, 13, 14, the front camera lens receiving half of a camera case 200 may engage a case gasket 16 and be temporarily joined to the case receiving surface 11, 12, 13, 14, by the camera case latching element 211 complementarily mating and removably coupling to a case locking tab 41, 42, 43, 44.

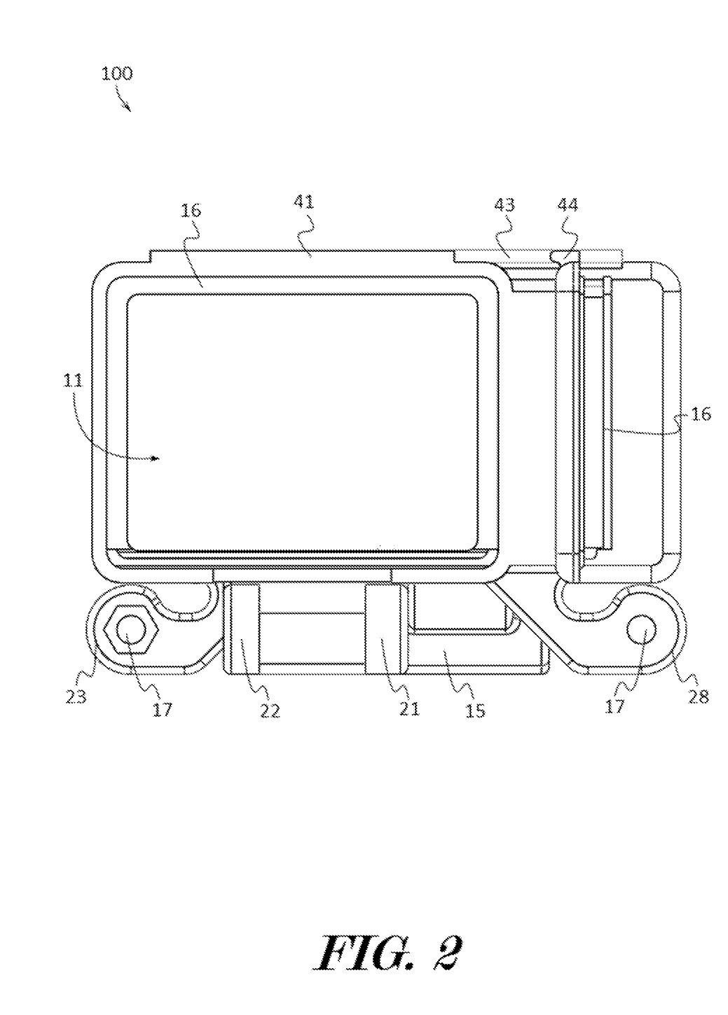

Turning now to FIG. 7, a perspective view of an example of a camera positioning and mounting apparatus 100 securing four front camera lens receiving halves of four camera cases 200 with attached suction cups 400 (also shown in FIG. 6) according to various embodiments is depicted. In this and other embodiments, one or more optional mounting accessories such as suction cups 400 may be attached with a fastener 205 to one or more mounting arms 21, 22, 23, 24, 25, 26, 27, 28, allowing for additional methods of positioning and securing the apparatus 100 to various surfaces. In further embodiments, other mounting accessories such as poles, booms, harnesses, and any other mounting or positioning accessory may be attached to one or more mounting arms 21, 22, 23, 24, 25, 26, 27, 28, with a fastener 205, such as a threaded thumb screw, bolt, and the like, configured to insert through a mounting arm aperture 17 (FIGS. 1 and 2) and through portions of a mounting accessory such as a suction cup 400.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A camera positioning and mounting apparatus, the apparatus comprising;
a base;
a set of retaining arms with each retaining arm radially protruding outwardly way from the base; and
a set of case receiving surfaces with each case receiving surface configured to be removably coupled with a portion of a camera case.

2. The apparatus of claim 1, wherein each of the case receiving surfaces comprise a gasket.

3. The apparatus of claim 2, wherein the gasket is formed along a perimeter for each case receiving surface.

4. The apparatus of claim 1, wherein the case receiving surfaces are substantially planar and configured to contact the rear surface of a camera.

5. The apparatus of claim 1, wherein the retaining arms and case receiving surfaces are integrally formed as a rigid structure.

6. The apparatus of claim 1, wherein the set of case receiving surfaces are coupled to the set of retaining arms.

7. The apparatus of claim 1, wherein the set of case receiving surfaces each comprise a case locking tab.

8. The apparatus of claim 7, wherein the case locking tab is adapted to complementary mate with and be removably coupled to a camera case latching element.

9. The apparatus of claim 1, further comprising a set of mounting arms positioned proximate to each of the case receiving surfaces.

10. The apparatus of claim 1, wherein each case receiving surface is coupled to a pad wherein each pad is configured to be secured between a camera rear surface and the case receiving surface.

11. A camera positioning and mounting apparatus, the apparatus comprising;
a first retaining arm extending outwardly away from the center of the apparatus, said first retaining arm supporting a first case receiving surface;
a second retaining arm positioned adjacent to said first retaining arm and extending outwardly away from the center of the apparatus, said second retaining arm supporting a second case receiving surface;
a third retaining arm positioned adjacent to said second retaining arm and extending outwardly away from the center of the apparatus, said third retaining arm supporting a third case receiving surface;
a fourth retaining arm positioned adjacent to said third retaining arm and extending outwardly away from the center of the apparatus, said fourth retaining arm supporting a fourth case receiving surface; and
wherein said first, second, third, and fourth, case receiving surfaces are adapted to removably couple with a portion of a camera case.

12. The apparatus of claim 11, wherein the portion of the camera case is front camera lens receiving half.

13. The apparatus of claim 11, wherein each of the case receiving surfaces comprise a gasket.

14. The apparatus of claim 13, wherein the gasket is formed along a perimeter for each case receiving surface.

15. The apparatus of claim 11, wherein each of the retaining arms and case receiving surfaces are integrally formed as a rigid structure.

16. The apparatus of claim 11, wherein each of the case receiving surfaces are coupled to a retaining arm.

17. The apparatus of claim 11, wherein each of the case receiving surfaces comprise a case locking tab.

18. The apparatus of claim 17, wherein the case locking tab is adapted to complementary mate with and be removably coupled to a camera case latching element.

19. The apparatus of claim 11, further comprising a mounting arm positioned proximate to each of the case receiving surfaces.

20. The apparatus of claim 11, wherein each of the case receiving surfaces are coupled to a pad wherein each pad is configured to be secured between a camera rear surface and each of the case receiving surfaces.
